(19) United States
(12) Patent Application Publication
(10) Pub. No.: US 2026/0156193 A1
(43) Pub. Date: Jun. 4, 2026

(54) SERVICE MANAGEMENT METHOD AND SYSTEM, AND CONFIGURATION SERVER AND EDGE COMPUTING DEVICE

(71) Applicant: BOE Technology Group Co., Ltd., Beijing (CN)

(72) Inventors: Shiyi ZHANG, Beijing (CN); Peng HU, Beijing (CN)

(21) Appl. No.: 18/705,535

(22) PCT Filed: May 5, 2023
(86) PCT No.: PCT/CN2023/092262

§ 371 Date: Apr. 27, 2024

(30) Foreign Application Priority Data
May 18, 2022 (CN) 202210546081.X

(51) Int. Cl. H04L 67/51; G06F 8/65; G06F 9/445; H04L 41/0803

(52) U.S. Cl. CPC H04L 67/51; G06F 8/65; G06F 9/44526; H04L 41/0803

(57) ABSTRACT

Disclosed are a service management method and system, and a configuration server and an edge computing device. The system comprises: a configuration server, an edge computing device, a terminal device and a display device; the configuration server provides a front-end configuration page and receives configuration information by means of the front-end configuration page, the configuration information comprises the edge computing device, the terminal device and a required AI service, and the AI service comprises one or more edge applications; the configuration server performs edge application deployment on the edge computing device according to the configuration information, and receives a reasoning result from the edge computing device; the edge computing device acquires a multimedia data stream of the terminal device according to a deployed edge application, and performs application reasoning to obtain the reasoning result; and the display device performs display according to the reasoning result.

### CROSS-REFERENCE TO RELATED APPLICATIONS

The present application is a U.S. National Phase Entry of International Application No. PCT/CN2023/092262 having an international filing date of May 5, 2023, which claims priority to Chinese patent application No. 202210546081.X, filed to the CNIPA on May 18, 2022 and entitled “Service Management Method and System, and Configuration Server and Edge Computing Device”, contents of the above-identified applications should be regarded as being incorporated herein by reference.

### TECHNICAL FIELD

Embodiments of the present disclosure relates to, but is not limited to, the technical field of intelligent systems, in particular to a service management method, a system, a configuration server, and an edge computing device.

### BACKGROUND

Edge computing refers to an edge device platform, which integrates network, computing, storage, and application core capabilities on a side close to a source of objects or data, provides a nearest end service nearby. Its application programs are initiated on an edge side, which produces a faster network service response and meets basic requirements of the industry in real-time service, application intelligence, security and privacy protection, etc. Cloud computing may receive or access historical data of the edge computing in real time.

### SUMMARY

An embodiment of the present disclosure provides a service management system including a configuration server, an edge computing device, a terminal device, and a display device, wherein the edge computing device, the terminal device, and the display device are all local devices, and the configuration server is a cloud device, wherein the configuration server is configured to provide a front-end configuration page and receive configuration information through the front-end configuration page, the configuration information includes the edge computing device, the terminal device, and a required Artificial Intelligence (AI) service, wherein the AI service includes one or more edge applications; perform edge application deployment on the edge computing device according to the configuration information; and receive an inference result of the edge computing device; the edge computing device is configured to acquire a multimedia data stream of the terminal device according to a deployed edge application, and perform application inference according to the acquired multimedia data stream to obtain the inference result; and the display device is configured to display according to the inference result.

An embodiment of the present disclosure also provides a service management method, including: a configuration server receives configuration information through a front-end configuration page, wherein the configuration information includes an edge computing device, a terminal device, and a required AI service, wherein the AI service includes one or more edge applications; the configuration server performs edge application deployment on the edge computing device according to the configuration information; and the configuration server receives an inference result of the edge computing device.

An embodiment of the present disclosure also provides a configuration server, which includes a memory; and a processor coupled to the memory, wherein the processor is configured to perform acts of the service management method as described in any of the above based on instructions stored in the memory.

An embodiment of the present disclosure also provides a service management method, including: an edge computing device receives a container mirror image file, wherein the container mirror image file includes a configuration file, an executable file, a dynamic library, and an algorithm model; the edge computing device performs edge application deployment according to the container mirror image file; and the edge computing device acquires a multimedia data stream of the terminal device according to a deployed edge application, and performs application inference according to the acquired multimedia data stream to obtain an inference result.

An embodiment of the present disclosure also provides an edge computing device, which includes a memory; and a processor coupled to the memory, wherein the processor is configured to perform acts of the service management method as described in any of the above based on instructions stored in the memory.

An embodiment of the present disclosure also provides a computer storage medium on which a computer program is stored, and when the program is executed by a processor, the service management method according to any one of the above is implemented.

Other features and advantages of the present disclosure will be set forth in following specification, and moreover, partially become apparent from the specification, or are understood by implementing the present disclosure. Other advantages of the present disclosure may be achieved and obtained through solutions described in the specification and drawings.

### BRIEF DESCRIPTION OF DRAWINGS

Accompany drawings are used for providing further understanding of technical solutions of the present disclosure, and constitute a part of the specification. The accompany drawings, together with the embodiments of the present disclosure, are used for explaining the technical solutions of the present disclosure, and do not constitute limitations on the technical solutions of the present disclosure.

FIG. 1 is a schematic architecture diagram of a service management system according to an exemplary embodiment of the present disclosure.

FIG. 2 is a schematic flowchart of a service management method according to an exemplary embodiment of the present disclosure.

FIG. 3 is a schematic flowchart of another service management method according to an exemplary embodiment of the present disclosure.

FIG. 4 is a schematic flowchart of yet another service management method according to an exemplary embodiment of the present disclosure.

FIG. 5 is a schematic diagram of a service inference flow of an edge computing device according to an exemplary embodiment of the present disclosure.

FIG. 6 is a schematic architecture diagram of another service management system according to an exemplary embodiment of the present disclosure.

FIG. 7 is a schematic diagram of a cloud service and an edge service according to an exemplary embodiment of the present disclosure.

FIG. 8 is a schematic diagram of another cloud service and edge service according to an exemplary embodiment of the present disclosure.

FIG. 9 is a schematic diagram of a Kubernetes (K8S) service framework.

FIG. 10 is a schematic diagram of an Internet of Things edge service according to an exemplary embodiment of the present disclosure.

FIG. 11 is a schematic diagram of a structure of a service management system according to an exemplary embodiment of the present disclosure.

FIG. 12 is a schematic diagram of a structure of an edge gateway according to an exemplary embodiment of the present disclosure.

FIG. 13 is a schematic diagram of an edge node management flow according to an exemplary embodiment of the present disclosure.

### DETAILED DESCRIPTION

To make objectives, the technical solutions, and advantages of the present disclosure clearer, the embodiments of the present disclosure will be described in detail below in combination with the accompany drawings. It is to be noted that the embodiments in the present disclosure and features in the embodiments may be randomly combined with each other if there is no conflict.

Unless otherwise defined, technical terms or scientific terms used in the embodiments of the present disclosure should have usual meanings understood by those of ordinary skills in the art to which the present disclosure belongs. “First”, “second”, and similar terms used in the embodiments of the present disclosure do not represent any order, quantity, or importance, but are only used for distinguishing different components. “Include”, “contain”, or a similar term means that an element or article appearing before the term covers an element or article and equivalent thereof listed after the term, and other elements or articles are not excluded.

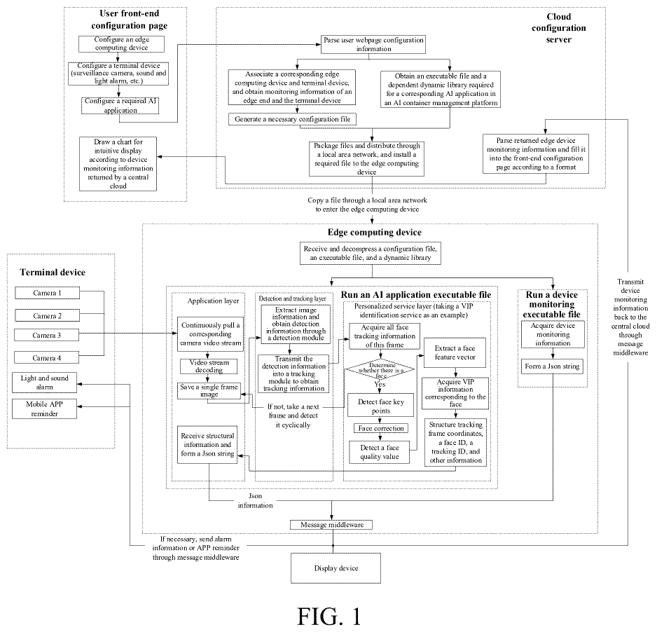

As shown in FIG. 1, an embodiment of the present disclosure provides a service management system including a configuration server, an edge computing device, a terminal device, and a display device, wherein the edge computing device, the terminal device, and the display device are all local devices, and the configuration server is a cloud device, wherein the configuration server is configured to provide a front-end configuration page and receive configuration information through the front-end configuration page, wherein the configuration information includes an edge computing device, a terminal device, and a required Artificial Intelligence (AI) service, and the AI service includes one or more edge applications; deploy an edge application to the edge computing device according to the configuration information; and receive an inference result of the edge computing device.

The edge computing device is configured to acquire a multimedia data stream of the terminal device according to the deployed edge application, and perform application inference according to the acquired multimedia data stream to obtain an inference result.

The display device is configured to display according to the inference result.

The service management system of the embodiment of the present disclosure undertakes all core computing power through the edge computing device, and the cloud configuration server only associates the edge computing device with the terminal device according to the user demand, distributes the edge application, and displays monitoring information of the bonded edge computing device in real time, and does not participate in a calculation operation process of the edge application. That is, the edge application operation process of the embodiment of the present disclosure is all at an edge end. This kind of architecture design may avoid frequently requesting data from a cloud end, thereby reducing insecurity of the data, reducing network delay, and improving a data processing efficiency and speed. The service management system is not only suitable for a scenario where a public cloud is allowed to participate, but also suitable for a scenario of building a private cloud with only an intranet, such as banks, transportation systems, and public security systems.

In some exemplary implementation modes, deploying the edge application to the edge computing device according to the configuration information includes: generating a configuration file according to the configuration information; acquiring an executable file, a dynamic library, and an algorithm model corresponding to the AI service in the configuration information; generating an edge application resource package, wherein the edge application resource package includes a configuration file, an executable file, a dynamic library, and an algorithm model; and transmitting the edge application resource package to the edge computing device through a network or a storage device.

In an exemplary embodiment, the generated edge application resource package may be transmitted to the edge computing device through a network such as Wireless Fidelity (WiFi), Bluetooth, and a local area network, or may be directly transmitted to the edge computing device through a storage device such as a Universal Serial Bus (USB) flash disk.

In other exemplary implementation modes, deploying the edge application to the edge computing device according to the configuration information includes: generating a configuration file according to the configuration information; acquiring an executable file, a dynamic library, and an algorithm model corresponding to the AI service in the configuration information; forming a container mirror image file according to the configuration file, the executable file, the dynamic library, and the algorithm model; and distributing the container mirror image file to the edge computing device through Kubegde (an open platform that enables edge computing).

In an exemplary embodiment, for the whole service management system, a KubeEdge architecture may be adopted, edge nodes, devices, and workloads are managed in the cloud end through a Kubernetes (K8S for short) standard Application Programming Interface (API), and system upgrades and application updates of edge nodes may be directly distributed from the cloud end, thus improving an efficiency of edge operation and maintenance. The edge computing device may be pre-installed with an edge part at the time of delivery and become a K8S node. The edge application may be distributed through Kubernetes. K8S is a brand-new distributed architecture solution based on a container technology, and is an open source container cluster management system.

In some exemplary implementation modes, one edge computing device may deploy multiple AI services, and each AI service may be implemented through one independent container, thereby achieving addition, monitoring, and maintenance of new services without affecting another service.

In some exemplary implementation modes, the configuration server is further configured to: compile and generate a new dynamic library and/or an executable file when updating the edge application; form a container mirror image file according to the new dynamic library and/or the executable file; and distribute the container mirror image file to the edge computing device to replace the dynamic library and/or the executable file of the current edge application.

A container mirror image file is a hierarchical file system that contains programs and corresponding data that may be run in a Linux kernel. In the embodiment, the container mirror image file includes a dynamic library and an executable file. Therefore, when the dynamic library and/or the executable file are updated, a container mirror image file may be formed according to a new dynamic library and/or executable file. The container mirror image file is distributed to the edge computing device to replace the dynamic library and/or the executable file of the current edge application, which takes less time for distributing and controls update of the program better.

In some exemplary implementation modes, the AI service includes an application layer, a detection and tracking layer, and a personalized service layer, wherein the application layer includes one or more application layer modules, the detection and tracking layer includes one or more detection and tracking modules, and the personalized service layer includes one or more personalized service modules, each module is connected to a main thread in a form of plug-in (different modules may be replaced by plug-in according to different requirements of customers after regular development of a unified interface).

For example, taking a Very Important Person (VIP) recognition service as an example, as shown in FIG. 1, the main thread of edge computing device includes: continuously pulling a corresponding camera video stream, decoding the video stream, retaining a single frame image, pulling image information, acquiring detection information through a detection module, transmitting detection information to a tracking module to obtain tracking information, then acquiring all face tracking information of this frame, determining whether there is a face, if so, detecting a key point of the face, performing face correction, detecting a face quality value, extracting a face feature vector, acquiring VIP information corresponding to the face, structuring tracking frame coordinates, a face ID, a tracking ID, and other information, and returning to an application layer module. The application layer module receives structural information to form a JavaScript Object Notation (Json) message string, which is output to a display device and a cloud configuration server through message middleware. In actual use, the personalized service layer may provide different personalized services according to different AI services, which is not limited in the embodiment of the present disclosure.

In the main thread, the application layer, the detection and tracking layer, and the personalized service layer are relatively separated, and each module of each layer is developed through plug-in structure. For example, a stream pulling module and a decoding module, etc. of the application layer, a detection module and a tracking module of the detection and tracking layer, a face detection module, a face key point algorithm module, a face correction module, a face quality algorithm module, and a face feature extraction algorithm module, etc. of the personalized service layer may all be designed in a form of plug-in, and each plug-in may be replaced with a same layer plug-in with different functions, thus reducing repeated development of services, keeping clarity of a function of each layer, and making maintenance of the function simpler and clearer.

In some exemplary implementation modes, the AI service includes multiple dynamic libraries compiled according to hardware data packages of different hardware platforms. By including multiple dynamic libraries compiled according to hardware data packages of different hardware platforms in the AI service, hardware of different manufacturers may be directly adapted and reasoned after being processed by the system, thus achieving purposes of rapid development, rapid deployment, and rapid delivery.

In some exemplary implementation modes, the AI service in the configuration information includes: a service name, a quantity of instances of container application, a mirror image name, a mirror image version, a container name, a container specification, and a container network type, wherein the container specification includes Central Processing Unit (CPU) quota, memory quota, whether to use an AI accelerator card, and an AI accelerator card type, and the container network type includes port mapping and host network.

Exemplarily, the AI accelerator card type may include: an Advanced Reduced Instruction Set Computing (RISC) Machines (ARM) mobile terminal or terminal, an Intel Central Processing Unit (CPU), an NVIDIA (which is an artificial intelligence computing company) Graphics Processing Unit (GPU), and an Artificial Intelligence (AI) chip, etc.

When the AI accelerator card type is the ARM mobile terminal or terminal, the system may select a Mobile Neural Network (MNN) and/or a Tensor Virtual Machine (TVM) for model acceleration. When the AI accelerator card type is the Intel CPU, the system may select Open Visual Inference & Neural Network Optimization (Open VINO) and/or TVM for model acceleration. When the AI accelerator card type is the NVIDIA GPU, the system may select TensorRT or TVM for model acceleration. When an AI chip of a specific AI chip manufacturer is used for the AI accelerator card type, an acceleration library of the specific AI chip manufacturer may be selected for model acceleration.

Exemplarily, the acceleration library of the AI chip manufacturer may include: RKNN, Questcore, the Ingenic acceleration library, and BitMain Neural Network SDk (BMNNSDK), etc. Among them, RKNN is specially used for a Rockchip (which is a digital audio and video processing chip company) embedded Neural-network Processing Unit (NPU) chip; Questcore is specially used for an AI chip of the Yitu Technology (which is a network technology Ltd.); the Ingenic Acceleration Library is specially used for an intelligent video chip of Ingenic Semiconductor Co., Ltd. (which is an integrated circuit Co., Ltd.); the BitMain Neural Network SDk (BMNNSDK) is specially used for an AI chip of Computing Energy Technology (which is a science and technology Ltd.). In actual use, the acceleration library of the AI chip manufacturer is not limited to these types listed above, and the present disclosure is not limited thereto.

In an embodiment of the present disclosure, the container network type supports two modes: port mapping and host network.

Among them, in the port mapping mode, a container network is virtualized and isolated, and a container has a separate virtual network, so communication between the container and the outside needs port mapping with a host. When the port mapping is configured, traffic flowing to a host port is mapped to a corresponding container port. For example, if a container port 80 is mapped to a host port 8080, traffic from the host port 8080 will flow to the container port 80.

In the host network mode, the container uses a network of a host (edge node), that is, the container and the host use a same Internet Protocol (IP) without network isolation.

In some exemplary implementation modes, the service management system may further include an edge gateway, wherein the edge computing device and the terminal device are connected with each other through the edge gateway; the edge gateway includes multiple pluggable hardware communication protocol plug-ins, and the hardware communication protocol includes at least two of following: 5G, 4G, WIFI, Ethernet, wireless 433 MHz frequency band communication, Bluetooth (BT), infrared, and ZigBee.

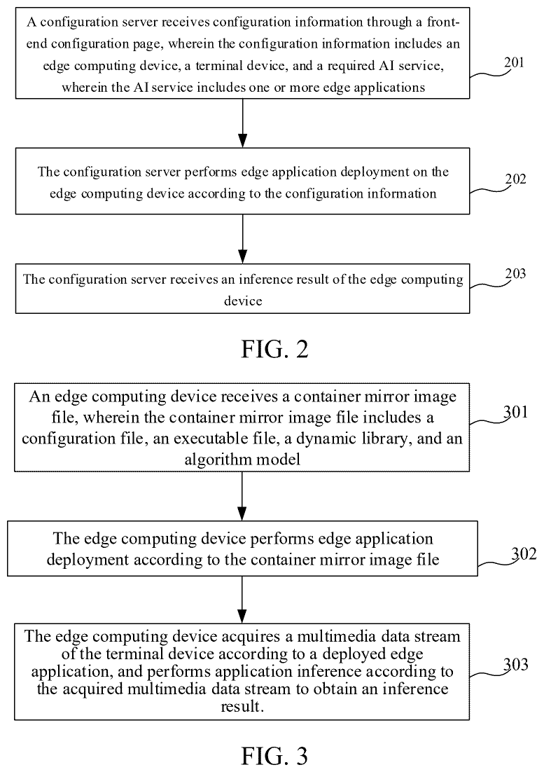

As shown in FIG. 2, a service management method is provided in an embodiment of the present disclosure. The method includes following acts.

Act 201: a configuration server receives configuration information through a front-end configuration page, wherein the configuration information includes an edge computing device, a terminal device, and a required AI service, wherein the AI service includes one or more edge applications.

Act 202: the configuration server performs edge application deployment on the edge computing device according to the configuration information.

Act 203: the configuration server receives an inference result of the edge computing device.

According to the service management method of the embodiment of the present disclosure, the corresponding edge computing device and the terminal device are configured according to the configuration information, and a corresponding edge application is distributed, so that an intelligent application is deployed from a cloud end to an edge in a lightweight manner, and a service demand of users for edge cloud cooperation of the intelligent application is met.

In some exemplary implementation modes, the service management method further includes: the configuration server acquires device monitoring information of the edge computing device, and stores or displays the device monitoring information.

In the embodiment, the configuration server may monitor a hardware usage situation of the edge computing device, and may display an application usage situation of the edge computing device through the configuration page.

In some exemplary implementation modes, the configuration server is located in a central cloud or a private cloud.

According to the service management method of the embodiment of the present disclosure, the edge computing device takes on all core computing power, and the cloud end (exemplarily, the cloud end may be a central cloud end, or a server or a host located in the private cloud) only associates the edge computing device with the terminal device according to a user demand, distributes an edge application and displays monitoring information of the bonded edge computing device in real time, and does not participate in a computing operation process of the edge application. That is, an edge application operation process of the embodiment of the present disclosure is all at an edge end. Under a design of this architecture, the service management method is not only applicable to a scene where a public cloud is allowed to participate, but also suitable for a scene of building a private cloud with only an intranet, such as a bank, a traffic system, and a public security system.

An embodiment of the present disclosure also provides a configuration server, which includes a memory; and a processor coupled to the memory, wherein the processor is configured to perform acts of the service management method as described in any of the above embodiments based on instructions stored in the memory.

An embodiment of the present disclosure also provides a computer storage medium, on which a computer program is stored, and when the program is executed by a processor, the service management method according to any one of the above embodiments is implemented.

As shown in FIG. 3, an embodiment of the present disclosure also provides a service management method. The method includes following acts.

Act 301: an edge computing device receives a container mirror image file, wherein the container mirror image file includes a configuration file, an executable file, a dynamic library, and an algorithm model.

Act 302: the edge computing device performs edge application deployment according to the container mirror image file.

Act 303: the edge computing device acquires a multimedia data stream of a terminal device according to a deployed edge application, and performs application inference according to the acquired multimedia data stream to obtain an inference result.

In some exemplary implementation modes, the service management method further includes: act 304: the edge computing device sends the inference result to an information publish system to push advertisement information or alarm information corresponding to the inference result through the information publish system.

In the embodiment of the present disclosure, the edge computing device may send the inference result to the information publish system, and the information publish system pushes the advertisement information or alarm information corresponding to the inference result to a display device, and may also directly display the inference result through the display device.

In some exemplary implementation modes, one or more of edge applications constitute an AI service, wherein the AI service includes an application layer, a detection and tracking layer, and a personalized service layer, wherein the application layer includes a stream pulling module, a decoding module, a daemon module, and a device monitoring module, wherein the detection and tracking layer includes a detection module and a tracking module, and the edge computing device performing application inference according to the deployed edge applications includes: the edge computing device pulls a video stream of the terminal device through the stream pulling module, decodes the video stream through the decoding module, outputs a single frame image to the detection and tracking module, obtains device monitoring information through the device monitoring module, and monitors whether the stream pulling module runs normally through the daemon module; the edge computing device performs target detection on the single frame image through the detection module, and tracks a detected target through the tracking module; and the edge computing device receives target detection information and tracking information through a module of the personalized service layer, and performs personalized service inference.

In some exemplary implementation modes, the service management method further includes: the edge computing device selects a target detection model selected by the detection module and a tracking algorithm selected by the tracking module according to a hardware type or user requirements.

In some exemplary implementation modes, the edge computing device may be an edge computing device loaded with an ARM architecture CPU. A computing energy consumption ratio of an ARM CPU device is far lower than that of an X86 architecture CPU. Therefore, the edge computing device equipped with an ARM CPU, even if computing power is slightly lower, has better environmental adaptability because of its characteristics of low power consumption and low calorific value, and does not need to be specially installed in a computer room when deployed in the field. While ab X86 architecture computing device must be equipped with a high-power cooling fan as a compromise of its high power, and because of a great noise of the high-power cooling fan, it must be put into a computer room to ensure a necessary working environment. For different hardware, platforms built by an upper layer will be different.

In some exemplary implementation modes, an algorithm model of the edge computing device is encapsulated in a form of plug-in, and the edge computing device supports heterogeneous hardware such as X86, ARM, Network Processing Unit (NPU), and GPU.

In the embodiment, algorithm models suitable for edge computing devices of different manufacturers are encapsulated through a development form of plug-in to be compatible with edge computing devices of different manufacturers, and the edge computing devices support accelerated inference deployment of various hardware platforms, thus reducing scenarios limited by hardware when in use. After hardware of different manufacturers is processed in the embodiment of the present disclosure, they may be directly adapted and reasoned, thus achieving purposes of rapid development, rapid deployment, and rapid delivery. The service management method of the embodiment of the present disclosure summarizes a set of transplant flows and codes which give consideration to both a development efficiency and inference accuracy through continuous trial and error.

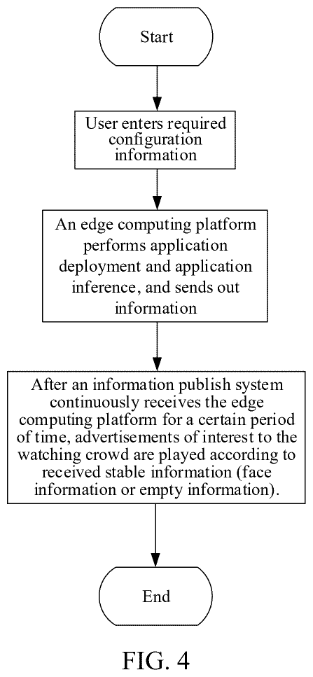

Exemplarily, when the service management method of the embodiment of the present disclosure is applied to an intelligent advertisement recommendation system, the intelligent advertisement recommendation system may include a configuration server, an edge computing device, a terminal device, and an information publish system. As shown in FIG. 4, a service management process of the intelligent advertisement recommendation system includes: a user inputs configuration information through the configuration server; the configuration server distributes a configuration file and an edge application of a corresponding function according to the configuration information input by the user; the edge computing device receives the configuration file and an installation file, configures a corresponding edge computing device and the terminal device (the information publish system device, a camera, etc.) according to the configuration file, the edge computing device deploys the edge application by using the installation file, performs application inference according to the deployed edge application, obtains an inference result, and sends inference result information to the information publish system, for example, the inference result is information such as gender and age; after continuously receiving the inference result information of the edge computing device for a period of time, the information publish system plays advertisements interested by viewers according to the inference result information, so as to maximize an advertising benefit.

A whole application program is circulated to form the intelligent advertisement recommendation system.

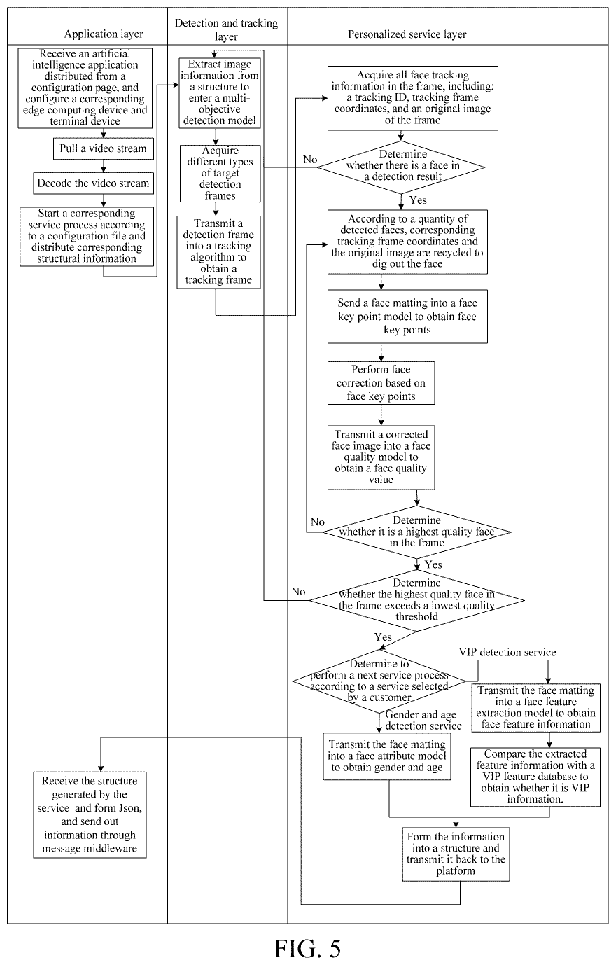

In some exemplary implementation modes, as shown in FIG. 5, an inference flow of the edge computing device includes: the user configures the edge computing device, the terminal device, and a required Artificial Intelligence (AI) application (i.e., edge application) through a front-end configuration page; the configuration server analyzes user configuration information, associates a corresponding edge computing device and terminal device, acquires monitoring information of the edge computing device and the terminal device, generates a configuration file, acquires an executable file and a dependent dynamic library required by a corresponding AI application in an AI Container management platform, and packages files and distributes them to the edge computing device; the edge computing device receives the packaged files and completes configuration and AI application installation; the application layer continuously pulls a video stream, decodes the pulled video stream, starts a corresponding service process according to the configuration file and sends corresponding structural information, wherein the structural information includes a decoded single frame image; the detection and tracking layer extracts the single frame image, acquires a multi-objective detection frame and corresponding information through a multi-objective detection model, and transmits the detection frame to a tracking algorithm to obtain a tracking ID, a tracking frame, and other tracking information; the personalized service layer acquires all face tracking information of the frame, including the tracking ID, tracking frame coordinates, and an original picture of the frame, determines whether there is a face in a detection result, if not, the process returns to a detection tracking module, if yes, cyclically uses the corresponding tracking frame coordinates and the original picture to dig out the face according to a quantity of detected faces, sends a face matting into a face key point model to obtain face key points, performs face correction according to the face key points, transmits a corrected face image into a face quality model to obtain a face quality value, determines whether the face is a highest quality face in the frame, if not, the process returns to dig out a next face matting until the highest quality face in the frame is obtained; determines whether the highest quality face in the frame exceeds a lowest quality threshold, if not, the process returns to the detection and tracking module, if yes, determines a next service process according to a service selected by a customer, for example, assuming that the service selected by the customer is a gender and age detection service, transmits the face matting to a face attribute model to obtain a gender and an age; assuming that the service selected by the customer is a Very Important Person (VIP) detection service, the face matting is transmitted into a face feature extraction model to obtain face feature information, and extracted feature information is compared with a VIP feature library to get whether it is VIP information; forms a service inference result information into a structure and transmits it back to the application layer; the application layer receives the service inference result to form a Json message string, and sends out a message through message middleware. Herein, the Json message string is a kind of storage format of message information, which facilitates unification of information formats, and the message middleware is a module supporting various message sending protocols, such as Message Queue Telemetry Transmission (MQTT) or Kafka; the edge computing device run a device monitoring executable file, acquires information such as Central Processing Unit (CPU), Graphics Processing Unit (GPU), A running memory, hard disk storage, and a device temperature, forms a Json message string, and sends out a message through the message middleware.

The message sent through the message middleware may be displayed through a web page or sent to the information publish system, and the information publish system is a terminal control system that receives information and issues commands. According to the inference result, the information publish system pushes advertisement information or alarm information corresponding to the inference result.

In order to ensure real-time performance of multi-objective detection and tracking and face recognition in a service, for the multi-objective detection model and other face-related models, TensorRT (an inference accelerator) or a bit continent network model compression tool is used to carry out operator fusion, Kernel function optimization, weight quantization processing, etc. on a model, and a throughput performance is optimized under a condition of acceptable precision loss, so as to ensure a real-time prediction ability when deployed and run on the edge end and a small computing device.

The edge computing device sends a final inference result to the information publish system through the message middleware. After continuously receiving a stable inference result sent by the edge computing device, the information publish system puts a corresponding advertisement picture or video on an advertisement screen or the financial screen according to the inference result, so as to maximize an advertisement benefit. The embodiment of the present disclosure combines an edge computing platform with artificial intelligence as a core with an information publish system to form an intelligent advertisement recommendation system which may be widely used.

The embodiment of the present disclosure abstracts development of edge end services into an edge computing platform, a core of the edge computing platform is AI applications, and each AI application includes three layers in structure: an application layer, a detection and tracking layer, and a personalized service layer, and the three layers are kept relatively separated to form a plug-in structure. Each plug-in in the platform may be replaced with a plug-in of a same layer with different functions, which reduces repeated development of a service, keeps functions of each layer clear, makes maintenance of functions simpler and clearer, improves a development efficiency, and reduces a difficulty of troubleshooting programs (debug) after development.

The embodiment of the present disclosure unifies detection (integrating detection of head, face, human body, motor vehicle, non-motor vehicle, etc.) and tracking (integrating tracking algorithms such as Sort and DeepSort) into the detection and tracking layer, which is used as a basic service of machine vision applied to video stream processing to uniformly output a detection and tracking result, which is convenient for program management and logic clarity. Business developers do not need to worry about content of detection and tracking when developing a new service. All video stream detection and tracking results will be directly output through the detection and tracking layer, and developers only need to obtain required content from them and complete an identification or classification task. In addition, the detection and tracking layer also performs a plug-in processing, and different detection algorithms and tracking algorithms are regularly developed through a unified interface, a plug-in may be replaced according to different hardware performances and customer requirements. For example, when computing power of the edge computing device is relatively small, a model with a relatively small parameter in a YOLOv5 target detection algorithm may be selected as a plug-in for unified detection, and Sort with less computing resource consumption may be used as a tracking algorithm. If the computing power of edge computing device is relatively large, an m or s model in YOLOv5 may be selected as a target detection model, and DeepSort, which consumes more computing resources but has good accuracy, may be used as a tracking algorithm, which may reduce a development cost and speed up a development progress.

According to the embodiment of the present disclosure, after receiving a user request through the cloud end, corresponding three levels of modules are selected according to the user request, and the three levels of modules (a source code is not distributed, only a compiled executable file and a dynamic library are distributed) are distributed to each edge computing device, all applications and services are completed in the edge computing device, that is, all modules for completing core calculation are completed at the edge end, and the cloud end is only used as a user configuration interface. A central cloud manages edge computing devices and devolves core computing to the edge computing devices, thus sharing a computing burden of the central cloud and improve real-time performance of an overall application which may greatly reduce a deployment cost and a development cost.

Each AI application of the embodiment of the present disclosure includes three layers in structure: an application layer, a detection and tracking layer, and a personalized service layer. Each layer includes multiple modules, which are connected into a data Pipeline (i.e., main thread) in a form of plug-in. According to different scenarios and service requirements, different modules are selected to be connected and compiled to form AI applications matching requirements, and new plug-ins are continuously added to adapt to more service scenarios and make the platform more efficient and stable.

The application layer may include a decoding module, an encoding module, a stream pulling module, a stream pushing module, a device monitoring module, a configuration management module, a data processing module, and a daemon module, etc.

The AI service provided by the present disclosure may include a VIP identification service, a gender identification service, a forbidden zone intrusion service, a bird eviction service, a hot zone statistics service, and the like.

The personalized service layer may include multiple basic algorithm modules. Exemplarily, the basic algorithm modules may include a face key point algorithm module, a face quality algorithm module, a face attribute algorithm module, a face feature extraction algorithm module, a vehicle brand recognition algorithm module, a vehicle color recognition algorithm module, an Optical Character Recognition (OCR) algorithm module, and the like.

An embodiment of the present disclosure also provides an edge computing device, which includes a memory; and a processor coupled to the memory, wherein the processor is configured to perform acts of the service management method as described in any of the above embodiments based on instructions stored in the memory.

An embodiment of the present disclosure also provides a computer storage medium, on which a computer program is stored, and when the program is executed by a processor, the service management method according to any one of the above embodiments is implemented. A method of driving service management of an edge computing device by executing executable instructions is basically the same as the service management method provided by the above embodiments of the present disclosure, and will not be described again here. An embodiment of the present disclosure provides a service management system based on an edge cloud, which relies on a cloud native technology to construct an edge cloud collaboration system, may run on various edge computing devices, and deploys rich intelligent applications such as AI, Internet of Things (IOT), and data analysis from a cloud end to an edge in a lightweight manner, thus meeting service demands of users for edge cloud collaboration of intelligent applications.

Users configure edge devices, AI functions, cameras, and other parameters in the cloud end, and send them to edge devices in a form of containers after editing and confirmation.

The edge computing device supports heterogeneous hardware access such as X86, ARM, NPU, and GPU, extends a capability of the central cloud to the edge, completes video intelligent analysis, text recognition, image recognition, big data stream processing, and other capabilities, and provides real-time intelligent analysis services nearby.

As an edge node, the edge computing device is safely connected to the cloud end, and application data is safely connected to the cloud.

The central cloud performs management, monitoring, and operation in a unified way, is compatible with native Kubernetes and Docker ecology, and supports management in forms of containers and function applications.

An embodiment of the present disclosure may provide three cloud computing service modes: Infrastructure as a Service (IaaS), Platform as a Service (PaaS), and Software-as-a-Service (Saas). By designing rich intelligent edge applications, the embodiment of the present disclosure provides more than 50 AI models such as stream processing, video analysis, text recognition, image recognition, etc. to be deployed to edge nodes for operation, and provides collaborative capabilities of edge applications and services on the cloud. Application details may be viewed in an edge application center and applications are deployed to edge nodes, thus providing users with a low-cost, out-of-the-box, and centralized operation and maintenance solution on the cloud.

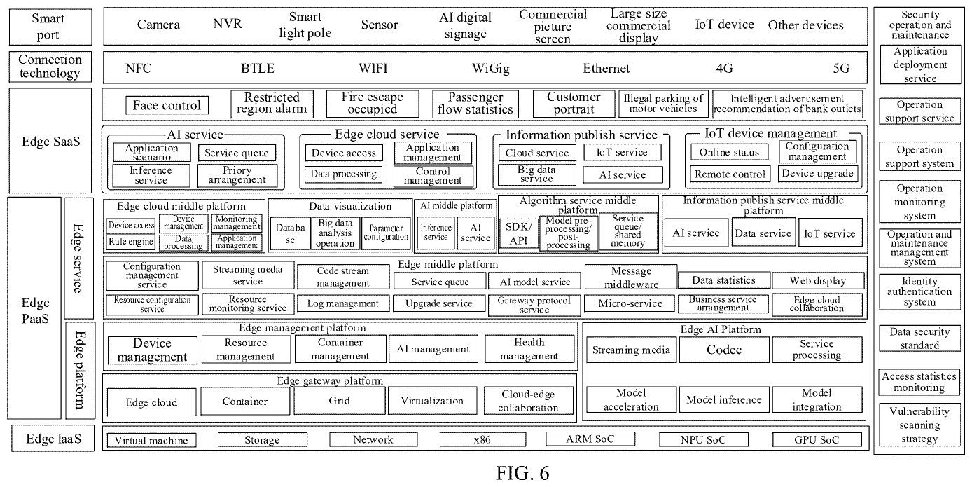

As shown in FIG. 6, an embodiment of the present disclosure may provide a complete set of end-to-end application solutions, and an input end may be terminal devices such as images, audio and video, sensors, content production, etc., and access an edge computing device through a connection technology such as 5G, 4G, WIFI, Ethernet, wireless 433 MHz band communication, Bluetooth, infrared, and ZigBee. An edge cloud is expansion of a cloud capability at an edge, which is divided into an edge application, an edge platform, and an edge infrastructure. The edge application includes more than 50 AI services such as face control and forbidden zone alarm. The edge platform provides services such as algorithm inference, application management, Internet of Things (IOT) management, configuration management, and device management to support service applications. The edge infrastructure supports a mainstream AI chip architecture such as ARM, NPU, X86, and RISC-V, as well as storage and network, and may be deployed in smart devices and computing nodes of different orders of magnitude.

The service management system of the embodiment of the present disclosure mainly includes three parts: a terminal device, an edge computing device, and a cloud device.

### 1. Terminal Device

The terminal device is connected to an Internet of Things (IOT) application development platform, and a non-standard device is converted into a standard object model, and connected to a gateway nearby, so as to achieve management and control of a device.

### 2. Edge Computing Device

After the terminal device is connected to an edge gateway, the edge gateway may achieve collection, circulation, storage, analysis, and reporting of device data to a cloud end. At the same time, the gateway provides a rule engine and a function calculation engine, which is convenient for scene arrangement and service expansion.

### 3. Cloud Device

After the device data is uploaded to the cloud end, it may combine with functions of a central cloud, such as big data and AI learning, and achieve more functions and applications through a standard API interface.

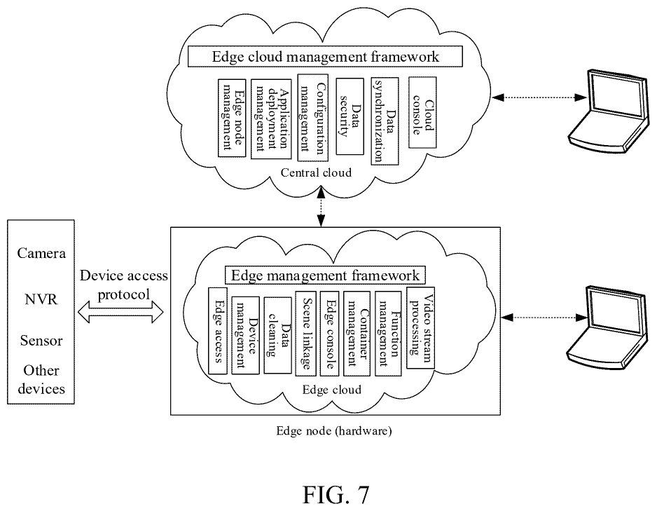

As shown in FIG. 7, the terminal device accesses the edge computing device through a variety of device access protocols, the terminal device includes, but are not limited to, a camera, a Network Video Recorder (NVR), a sensor, and the like. The edge computing device (i.e., an edge node, an edge cloud) supports edge access, device management, data cleaning, scene linkage, edge console, container management, function management, and video stream processing capabilities, while the cloud end (central cloud) supports services such as edge node management, application deployment management, configuration management, data security, data synchronization, and cloud console. The system manages gateways and sub-devices related to the edge end by instance, and may also manage scene linkage, function calculation, stream data analysis, and message routing content. Resources in an edge instance are deployed to the gateways by deploying the instance.

The system provides a variety of device access protocols, so that the terminal device may easily access the edge computing device.

Scene linkage achieves local management, linkage, and control of multiple terminal devices. For example, scene linkage may connect two operations of “opening a door” and “turning on light” in series, and set a time interval between 18:00 and 19:00, so that the door opens and the light lights up in a fixed time period. Scene linkage is a visual programming method for developing automation service logic in the rule engine, which may define linkage rules between devices in a visual way and deploy the rules to the cloud end or edge end.

The system supports following two edge applications: a function calculation application and a container mirror image application.

Function calculation application: function calculation is a Runtime framework, which may complete development of a device accessing to an edge gateway and development of service logic based on device data and events. At present, there are a cloud product mode (used in combination with an Alibaba Cloud function computing product) and a local direct upload mode.

Container mirror image application: container mirror image application is an edge application based on a container technology, which may directly pull a mirror image from a mirror image warehouse as an edge application.

Application management is an edge application management ability, which may standardize management of a version and configuration of an edge end application.

The edge computing device provides a stream data analysis capability. Edge stream data analysis is extension of central cloud stream computing, which solves unique problems of Internet of Things scenarios.

The Internet of Things needs to collect data at a high frequency. The data itself has a large amount and changes little, and a value of original data is relatively low. Stream data analysis may clean, process, and aggregate the data before going to the cloud, which greatly reduces a cost of data transmission.

A connection between the edge end and the cloud is unstable, and uploading data to the cloud cannot meet requirements of real-time computing. Stream data analysis runs in the edge end, so it does not rely on a network and processes data with low delay.

The edge computing device provides a message routing capability. A message routing path may be set in the edge computing device to control flow of local data in the edge computing device, thus achieving safety and controllability of data. The provided message routing path includes: device to Internet of Things access hub (IoT Hub) (cloud end), device to function calculation, device to stream data analysis, function calculation to function calculation, function calculation to IoT Hub, stream data analysis to IoT Hub, stream data analysis to function calculation, and IoT Hub to function calculation.

The edge computing device provides an ability to continue transmission when a network is disconnected, and provide an ability of data recovery when the network is disconnected or weak. Quality of Service (QoS) may be set when configuring message routing, so that device data may be saved in local storage area under a situation that the network is disconnected, and then cached data may be synchronized to the cloud end after the network is restored.

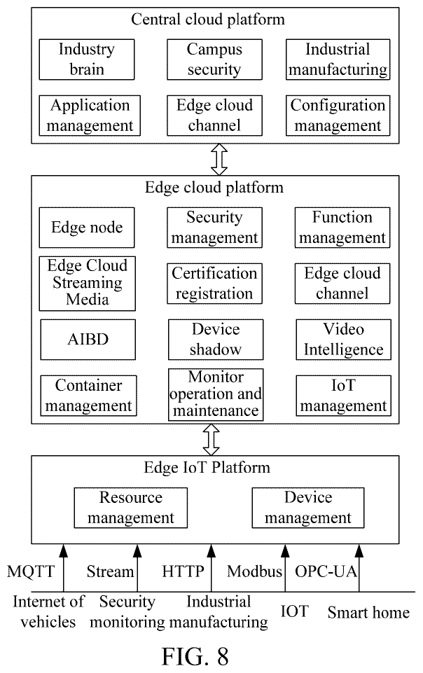

As shown in FIG. 8, a central cloud platform supports industry brain, campus security, industrial manufacturing, application management, edge cloud channel, and configuration management, etc., and an edge cloud platform supports edge nodes, security management, function management, edge cloud streaming media, authentication registration, edge cloud channel, Artificial Intelligence Big Data (AIBD), device shadow, video intelligence, container management, monitoring operation, and IOT management, etc. An edge IOT platform supports resource management and device management. The edge IOT platform may be used for Internet of vehicles, security monitoring, industrial manufacturing, IOT, smart home, etc. The edge IOT platform supports Message Queue Telemetry Transmission (MQTT), Stream, Hyper Text Transfer Protocol (HTTP), Modbus (a serial communication protocol), Object Linking and Embedding (OLE) for Process Control (OPC) Unified Architecture (OPC-UA), and other communication protocols.

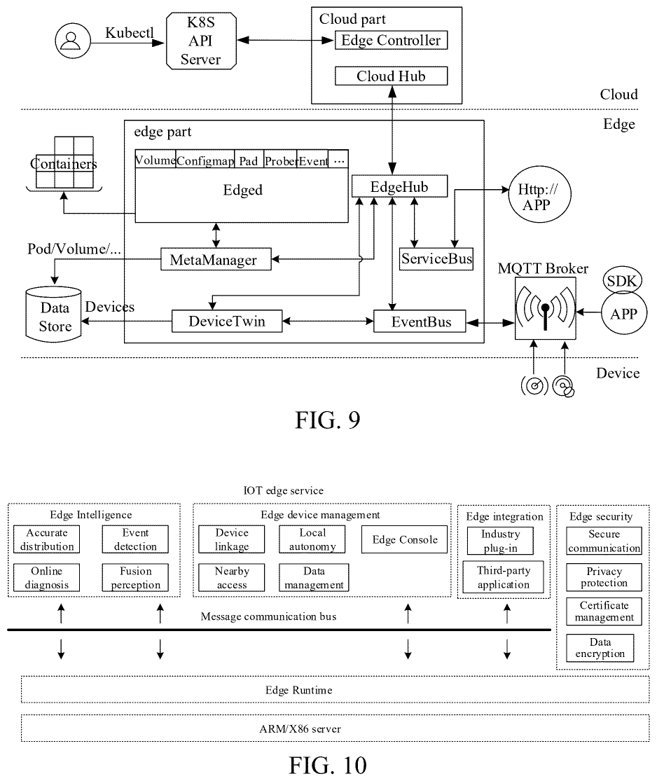

As shown in FIG. 9, the system may adopt a KubeEdge (an open platform enabling edge computing) architecture, and manage edge nodes, devices, and workloads in the cloud end through a Kubernetes (K8S for short) standard API. System upgrade and application update of edge nodes may be directly distributed from the cloud end, which improves an efficiency of edge operation and maintenance. The edge computing device may be pre-installed with an edge part at the time of delivery and become a K8S node. An edge application may be distributed through Kubernetes. K8S is a brand-new distributed architecture solution based on a container technology, and is an open source container cluster management system.

A cloud process of KubeEdge includes two components: a Cloud Hub and an Edge Controller, wherein the Cloud Hub is configured to receive information synchronized by an Edge Hub to the cloud end, and the Edge Controller is configured to control state synchronization between a Kubernetes API Server and edge nodes, applications, and configurations.

An edge process of KubeEdge mainly includes five components: Edged, Meta Manager, Edge Hub, Device Twin, and EventBus. Among them, Edged is a lightweight node agent Kubelet, which achieves life cycle management of K8S resource objects such as Pod, Volume, and Node. Meta Manager is responsible for persistence of local metadata, which is a key to an autonomy ability of an edge node. Edge Hub is a multiplexed message channel that provides reliable and efficient cloud-edge information synchronization. Device Twin is configured to abstract physical devices and to generate a mapping of device states in the cloud end. EventBus subscribes to device data from an MQTT server (Broker).

The edge computing platform of the embodiment of the invention may achieve edge autonomous management, an original database is disposed on an edge side for storing a calculation result of the edge computing platform, and the original database can ensure that the edge side may run autonomously even when a cloud edge channel is broken. Access of devices may quickly expand objects, models, etc. through Kubernetes Custom Resource Definition (CRD). CRD allows users to define new resource types and expand clustering capabilities based on existing Kubernetes resources. The edge computing platform of the embodiment of the present disclosure can also achieve edge cloud flow management, i.e., achieve communication load balance between a cloud and an edge, communication between an edge and an edge, publishing, and other capabilities.

As shown in FIG. 10, the edge computing device supports IOT edge services, which include edge intelligence, edge device management, edge integration, and edge security, wherein edge intelligence includes accurate distribution, event detection, online diagnosis, and fusion perception, edge device management includes device linkage, local autonomy, edge console, nearby access, and data management, etc., edge integration includes industry plug-ins and third-party applications, and edge security includes secure communication, privacy protection, certificate management, and data encryption, etc.

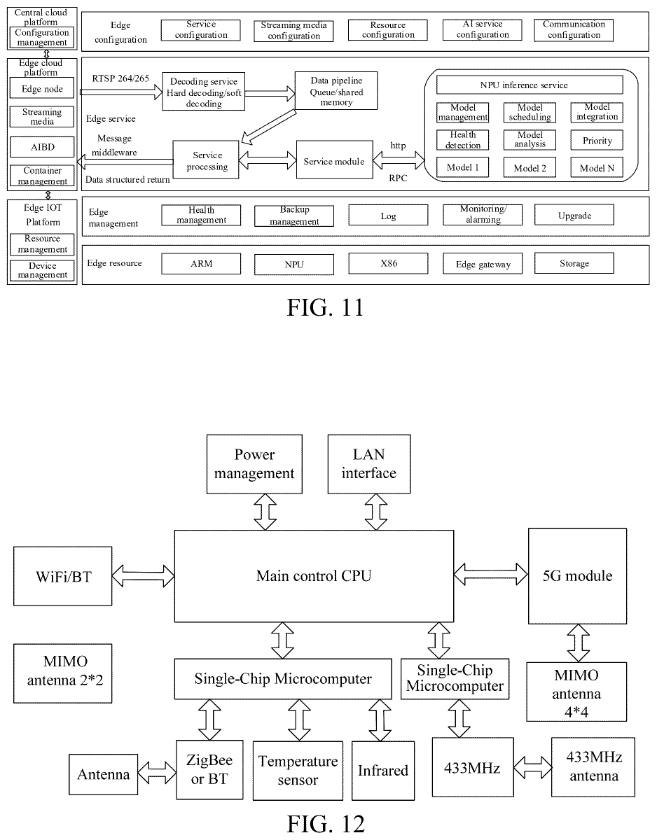

As shown in FIG. 11, an entire system may include a central cloud platform, an edge cloud platform, and an edge IOT platform. The central cloud platform provides edge configuration, the edge configuration includes service configuration, streaming media configuration, resource configuration, AI service configuration, and communication configuration. The edge cloud platform provides edge services, wherein the edge services include decoding service, data pipeline, service processing, NPU inference service, etc. The NPU inference service includes model management, model scheduling, model integration, health detection, model analysis, priority, etc. A decoding service module obtains video streams for processing through a Real Time Streaming Protocol (RTSP), and a service module calls NPU inference service through a Hyper Text Transfer Protocol (HTTP) or Remote Procedure Call (RPC). Service processing returns data through message middleware or data structure. The edge IOT platform provides resource management and device management, wherein edge resources support heterogeneous hardware access such as X86, ARM, NPU, and GPU, edge gateway, edge storage, and other functions, and device management supports health management, backup management, log, monitoring/alarm, upgrade, and so on.

The entire system may also be divided into five functional modules: central cloud management, edge cloud native, edge side AI inference, cloud configuration visualization, and edge display visualization, and an edge gateway. Central cloud management is responsible for managing edge application life cycle management, compatible with native K8S and Docker ecology, supporting management in a form of container and function application, and helping users to manage, monitor, and operate edge applications uniformly in the cloud end. The edge cloud adopts a KubeEdge architecture, relying on container arrangement and scheduling capability of K8S to achieve cloud-edge collaboration, computing sinking, and smooth access of massive devices. Edge side AI inference is presented in a form of heterogeneous hardware of edge nodes, which is compatible with a mainstream AI chip architecture such as ARM, NPU, X86, and RISC-V. Cloud configuration visualization achieves configuration of edge nodes, AI service capabilities, and cameras; edge display achieves data visualization. The edge gateway makes the entire system have hardware communication protocol functions such as 5G, 4G, WIFI, Ethernet (Local Area Network (LAN)), 433 MHz, Bluetooth (BT), Infrared, and ZigBee. The hardware may be pluggable and users may choose to use it.

The present system supports the original ecology of Kubernetes and Docter. Edge applications may be seamlessly migrated from the cloud end to the edge side. The central cloud supports management and arrangement of micro-services, which may be deployed to a container engine on the cloud or to the edge side. Edge applications may be interoperable on the cloud and on the edge. The central cloud supports traffic governance, which includes load balancing. The central cloud supports monitoring of edge nodes, etc.

The cloud end defines edge service intelligence: intelligent video analysis, machine inference, big data stream processing, and other intelligence developed in the cloud end may be pushed to the edge to provide real-time service capabilities nearby.

The cloud end centralized management of edge node application life cycle: in the cloud end, edge computing services may centrally manage container and function application deployment, configuration change, version upgrade, monitoring, operation and maintenance analysis distributed on hundreds of thousands of edge computing gateways.

Open agile lightweight edge platform: container applications supporting an Open Container Initiative (OCI) mirror image (Docker mirror image) format and simple developed function applications are pushed to edge nodes, with a minimum computing resource specification of 1vCPU and 128 MB of memory; which quickly enables cloud-edge interaction between campus devices and applications.

Secure edge-cloud collaboration: an edge device is securely connected to a cloud platform, and cloud-edge secure interaction of application data is performed.

KubeEdge is a first framework for edge computing in China. It is 100% compatible with a K8S API. It is divided into two parts: on the cloud and below the cloud, i.e., K8S may be deployed to edge nodes or to cloud data centers on the cloud. They communicate with each other through a secure channel.

The present system supports edge autonomous management and edge cloud traffic management, wherein edge autonomous management: an original database is set on the edge side, which can ensure that if the secure channel is broken, the edge side may also run autonomously. Edge cloud traffic management: that is, an ability to balance loads of cloud and edge communication, edge-to-edge communication, and publishing, etc.

The present system provides rich edge AI algorithms, which may extend capabilities of central cloud AI to edges, such as face recognition, vehicle recognition, perimeter intrusion, text recognition, and other AI capabilities, and low-cost and high-performance edge AI computing power.

Interface diversification: supporting multiple hardware interfaces and multiple protocol interfaces.

Hardware serialization: according to different industries and scenarios, it supports selection of different edge hardware, including various hardware based on Kunpeng, X86, and an ARM architecture.

Software standardization: unified framework, loosely coupled with hardware, capable of docking general servers, and supporting pluggable edge services.

Application ecologicalization: an open architecture supports integration of third-party services, supports realization of full-scenario customized solutions, and provides rich fertile soil for application ecology.

The service management system provides an ability to extend applications on the cloud to the edge by managing edge nodes of users, and links data of the edge and the cloud. At the same time, it provides unified operation and maintenance capabilities such as edge node/application monitoring and log collection in the cloud end, providing enterprises with complete edge computing solutions. It is mainly divided into two acts: first, registering an edge node; second, managing the edge node and distributing one container application to the edge node.

As shown in FIG. 12, an industrial-grade edge gateway makes the entire system have hardware communication protocol functions such as 5G, 4G, WIFI, LAN Ethernet, 433 MHz, BT Bluetooth, infrared, and ZigBee. The hardware may be pluggable and users may choose to use it.

The system may use a service instance as a management edge node, distribute an application management cluster, log in to a cloud configuration management console, create the service instance and configure appropriate parameters, wherein the parameters may include a region where the service instance is located, an instance name, an edge cloud access mode, an edge cloud node scale, an access bandwidth, advanced settings, etc. Service instances between different regions do not communicate with each other, and the edge cloud access mode includes “Internet access” and “dedicated line access”. The edge node scale is a scale of edge nodes that the service instance may manage, for example, the edge node scale may be 50, 200, 1000 nodes. When the access mode is “Internet access”, according to the edge node scale, an access bandwidth corresponds to 5 Mbit/s, 10 Mbit/s, and 30 Mbit/s respectively. An access bandwidth of “dedicated line access” is determined by a dedicated line. The advanced settings are used for multi-available region deployment, that is, service instances are deployed in multiple available regions, support multi-available region disaster tolerance, but have a loss in cluster performance.

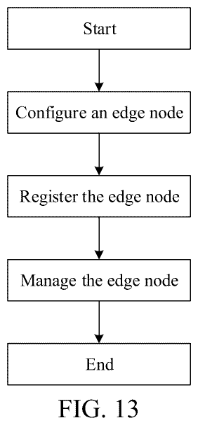

As shown in FIG. 13, in order to enable the system to manage edge nodes, following operations are required: configuring the edge nodes, registering the edge nodes, and managing the edge nodes.

The edge nodes may be either physical machines or virtual machines. Configuring the edge nodes includes GPU drive configuration, NPU drive configuration, installing Docker on the edge nodes and checking Docker status, configuring firewall rules of the edge nodes, etc.

Registering the edge nodes includes selecting a registered edge node type (self-built node or intelligent edge node), configuring basic information of the edge nodes (name, description, label, region, CPU architecture, specification, operating system, system disk, edge virtual private cloud, elastic public network IP, address pool, and login credential), configuring advanced information of the edge nodes (bonding device, whether to enable Docker, listening address, and system log), and obtaining edge node configuration files and installation programs after configuration is completed. Wherein, names of edge nodes allow Chinese, English letters, numbers, midline, and underline, and labels of edge nodes may be used for marking resources, which is convenient for classification management. If a same label is needed to identify multiple cloud resources, that is, all services may choose the same label. The region is used for selecting an edge site where an edge node is located. The address pool is used for selecting an operator line of the elastic public network IP. A security group is used for selecting a security group that an instance needs to join. The login credential supports use a method of setting an initial password as an authentication method of an edge instance, at this time, the edge instance may be logged in by user name and password. When setting advanced information of an edge node, the bonding device is used for bonding a terminal device for the edge node, and the terminal device may still be bonded after registering the edge node. Whether to enable Docker: after enabling, it may support deployment of container applications, otherwise, it only supports deployment of function applications. Listening address: a listening address of MQTT broker built in the edge node is used for sending and receiving edge cloud messages. System log: log generated by software on edge nodes. Application log: log generated by applications deployed on edge nodes.

Managing edge nodes is to install edge core software EdgeCore on an actual edge node by using an installation program and a configuration file downloaded from a registered edge node, so that the edge node may be connected with the cloud end and be included in cloud management. When the edge node is first managed, the system automatically installs a latest version of the edge core software EdgeCore.

The system supports distributing container applications to edge nodes (a compiling environment of the system exists in a cloud container warehouse, and service containers are distributed to edge nodes (edge computing devices) through the edge cloud). The following two types of container applications may be distributed: edge applications in an edge market or custom edge applications. Custom edge applications may select defined application templates, modify them on a basis of the selected application templates, or configure container applications from scratch. When creating a container application, an edge node will pull a mirror image from a container mirror image service. An architecture of the container mirror image must be consistent with a node architecture. For example, if a node is X86, the architecture of the container mirror image must also be X86.

When creating a container application, it is necessary to configure basic information of the container application, configure a container, deploy configuration, access configuration and so on.

Among them, configuring the basic information of the container application includes configuring a name of the container application, a quantity of instances of the container application, a configuration method, a label and other information.

Configuring the container includes selecting a mirror image to be deployed, a mirror image version, and a container specification, etc. The mirror image to be deployed may be all mirror images created by a user himself in the container mirror image service, or may be a mirror image shared by other users.

Deployment configuration supports two methods: specifying edge nodes or automatic scheduling. When automatic scheduling is selected, a container application is automatically scheduled within an edge node group according to resource usage. At this time, a failure policy may be set, the failure policy is used for specifying whether to reschedule an application instance and migrate it to another available node in the edge node group when an edge node where the application instance is located is unavailable. Additionally, advanced configurations such as a restart strategy or a Host Process ID (Host PID) may also be performed on the container. The restart strategy includes: always restart, restart in case of failure, and not restart.

Among them, always restart: when the application container exits, whether it exits normally or abnormally, the system will pull up the application container again. When using a node group, the restart strategy is “always restart”. Restart in case of failure: when the application container exits abnormally, the system will pull up the application container again, and when it exits normally, it will no longer pull up the application container. Not restart: when the application container exits, whether it exits normally or abnormally, the system will not pull up the application container again.

When the Host PID is enabled, the container and an edge node host share PID namespace, so that they can operate with each other on the container or edge node, such as starting and stopping a process of the edge node in the container and starting and stopping a process of the container in the edge node.

Access configuration supports port mapping and host network.

Port mapping means that a container network is virtualized and isolated. The container has a separate virtual network, and communication between the container and the outside needs port mapping with a host. When the port mapping is configured, traffic to a host port is mapped to a corresponding container port. For example, if a container port 80 is mapped to a host port 8080, traffic from the host port 8080 will flow to the container port 80. A host network card may be selected for port mapping.

Host network is a network in which a container uses a host (edge node), and the container and the host do not do network isolation and use a same IP.

After an application is deployed, the application may be updated and upgraded, access configuration of the application may be modified, etc.

According to the service management method, the system, the configuration server, and the edge computing device provided by the embodiments of the present disclosure, he edge computing device takes on all core computing power, the cloud end only associates the edge computing device with the terminal device according to a user demand, distributes an edge application and displays monitoring information of a bonded edge computing device in real time, and does not participate in a calculation and operation process of the edge application. That is, an edge application operation process of the embodiments of the present disclosure is all at an edge end. Under a design of this architecture, the service management method is not only applicable to a scene where a public cloud is allowed to participate, but also suitable for a scene of building a private cloud with only an intranet, such as a bank, a traffic system, and a public security system.

The present disclosure designs a standardized, automated, and modular service management system, which supports selection of different edge hardware for different industries and scenarios, including various hardware based on Kunpeng, X86, and ARM architectures, supports more than 50 edge side AI capabilities and millions of edge node management, provides an ability to extend cloud applications to the edge, links data of the edge and the cloud end, and provides unified edge node/application monitoring, log collection and other operation and maintenance capabilities in the cloud end to provide enterprises with complete edge computing solutions.

Those of ordinary skills in the art may understand that all or some of acts in the methods disclosed above, systems, functional modules or units in apparatuses may be implemented as software, firmware, hardware, and an appropriate combination thereof. In a hardware implementation mode, division of the function modules/units mentioned in the above description is not always corresponding to division of physical components. For example, a physical component may have multiple functions, or a function or an act may be executed by several physical components in cooperation. Some components or all components may be implemented as software executed by a processor such as a digital signal processor or a microprocessor, or implemented as hardware, or implemented as an integrated circuit such as a specific integrated circuit. Such software may be distributed on a computer readable medium, and the computer readable medium may include a computer storage medium (or a non-transitory medium) and a communication medium (or a transitory medium). As known to those of ordinary skills in the art, a term computer storage medium includes volatile or nonvolatile, and removable or irremovable media implemented in any method or technology for storing information (for example, a computer readable instruction, a data structure, a program module, or other data). The computer storage medium includes, but is not limited to, a Random Access Memory (RAM), a Read Only Memory (ROM), an Electrically Erasable Programmable Read Only Memory (EEPROM), a flash memory or another memory technology, a Compact Disc Read Only Memory (CD-ROM), a Digital Versatile Disk (DVD) or another optical disk storage, a magnetic cartridge, a magnetic tape, magnetic disk storage or another magnetic storage apparatus, or any other medium that may be configured to store desired information and may be accessed by a computer. In addition, it is known to those of ordinary skill in the art that the communication medium usually includes a computer readable instruction, a data structure, a program module, or other data in a modulated data signal of, such as, a carrier wave or another transmission mechanism, and may include any information delivery medium.

Although implementation modes disclosed in the present disclosure are as above, contents described are only implementation modes used for convenience of understanding of the present disclosure, but not intended to limit the present disclosure. Any person skilled in the art to which the present disclosure pertains may make any modifications and variations in a form and details of implementation without departing from the spirit and the scope of the present disclosure, but the protection scope of the present disclosure shall still be subject to the scope defined in the appended claims.

1. A service management system, comprising a configuration server, an edge computing device, a terminal device, and a display device, wherein the edge computing device, the terminal device, and the display device are all local devices, and the configuration server is a cloud device, wherein:
the configuration server is configured to provide a front-end configuration page and receive configuration information through the front-end configuration page, the configuration information comprises the edge computing device, the terminal device, and a required Artificial Intelligence (AI) service, wherein the AI service comprises one or more edge applications; perform edge application deployment on the edge computing device according to the configuration information; and receive an inference result of the edge computing device;
the edge computing device is configured to acquire a multimedia data stream of the terminal device according to a deployed edge application, and perform application inference according to the acquired multimedia data stream to obtain the inference result; and
the display device is configured to display according to the inference result.

2. The service management system according to claim 1, wherein performing edge application deployment on the edge computing device according to the configuration information comprises:
generating a configuration file according to the configuration information;
acquiring an executable file, a dynamic library, and an algorithm model corresponding to the AI service in the configuration information;
generating an edge application resource package, wherein the edge application resource package comprises a configuration file, an executable file, a dynamic library, and an algorithm model; and
transmitting the edge application resource package to the edge computing device through a network or a storage device.

3. The service management system according to claim 1, wherein performing edge application deployment on the edge computing device according to the configuration information comprises:
generating a configuration file according to the configuration information;
acquiring an executable file, a dynamic library, and an algorithm model corresponding to the AI service in the configuration information;
forming a container mirror image file according to the configuration file, the executable file, the dynamic library, and the algorithm model; and
distributing the container mirror image file to the edge computing device through Kubegde.

4. The service management system according to claim 3, wherein one edge computing device deploys a plurality of AI services, each of the AI services is implemented through one independent container.

5. The service management system according to claim 3, wherein the configuration server is further configured to
compile and generate a new dynamic library and/or executable file when updating the edge application;
form a container mirror image file according to the new dynamic library and/or executable file; and
distribute the container mirror image file to the edge computing device to replace the dynamic library and/or executable file of the current edge application.

6. The service management system according to claim 1, wherein the AI service comprises an application layer, a detection and tracking layer, and a personalized service layer, wherein the application layer comprises one or more application layer modules, the detection and tracking layer comprises one or more detection and tracking modules, and the personalized service layer comprises one or more personalized service modules, each module is connected to a main thread in a form of plug-in.

7. The service management system according to claim 1, wherein the AI service comprises a plurality of dynamic libraries compiled according to hardware data packages of different hardware platforms.

8. The service management system according to claim 1, wherein the AI service in the configuration information comprises: a service name, a quantity of instances of a container application, a mirror image name, a mirror image version, a container name, a container specification, and a container network type, wherein the container specification comprises Central Processing Unit (CPU) quota, memory quota, whether an AI accelerator card is used, an AI accelerator card type, and the container network type comprises port mapping and host network.

9. The service management system according to claim 1, further comprising an edge gateway, wherein:
the edge computing device and the terminal device are connected with each other through the edge gateway;
the edge gateway comprises a plurality of pluggable hardware communication protocol plug-ins, and a hardware communication protocol comprises at least two of following: 5G, 4G, Wireless Fidelity (WiFi), Ethernet, wireless 433 MHz frequency band communication, Bluetooth, infrared, and ZigBee.

10. A service management method, comprising:
receiving, by a configuration server, configuration information through a front-end configuration page, wherein the configuration information comprises an edge computing device, a terminal device, and a required Artificial Intelligence (AI) service, wherein the AI service comprises one or more edge applications;
performing, by the configuration server, edge application deployment on the edge computing device according to the configuration information; and
receiving, by the configuration server, an inference result of the edge computing device.

11. The service management method according to claim 10, further comprising:
acquiring, by the configuration server, device monitoring information of the edge computing device, and storing or displaying the device monitoring information.

12. The service management method according to claim 10, wherein the configuration server is located in a central cloud end or a private cloud end.

13. A configuration server, comprising a memory and a processor coupled to the memory, wherein the processor is configured to perform acts of a service management method according to claim 10 based on instructions stored in the memory.

14. A non-transitory computer storage medium, on which a computer program is stored, wherein when the computer program is executed by a processor, a service management method according to claim 10 is implemented.

15. A service management method, comprising:
receiving, by an edge computing device, a container mirror image file, wherein the container mirror image file comprises a configuration file, an executable file, a dynamic library, and an algorithm model;
performing, by the edge computing device, edge application deployment according to the container mirror image file; and
acquiring, by the edge computing device, a multimedia data stream of the terminal device according to a deployed edge application, and performing application inference according to the acquired multimedia data stream to obtain an inference result.

16. The service management method according to claim 15, further comprising:
sending, by the edge computing device, the inference result to an information publish system to push advertisement information or alarm information corresponding to the inference result through the information publish system.

17. The service management method according to claim 15, wherein one or more of edge applications constitute an Artificial Intelligence (AI) service, wherein the AI service comprises an application layer, a detection and tracking layer, and a personalized service layer, wherein the application layer comprises a stream pulling module, a decoding module, a daemon module, and a device monitoring module, wherein the detection and tracking layer comprises a detection module and a tracking module, and performing by the edge computing device application inference according to the deployed edge applications comprises:
pulling, by the edge computing device, a video stream of the terminal device through the stream pulling module, decoding the video stream through the decoding module, outputting a single frame image to the detection and tracking module, obtaining device monitoring information through the device monitoring module, and monitoring whether the stream pulling module runs normally through the daemon module;
performing, by the edge computing device, target detection on the single frame image through the detection module, and tracking a detected target through the tracking module; and
receiving, by the edge computing device, target detection information and tracking information through a module of the personalized service layer, and performing personalized service inference.

18. An edging computing device, comprising a memory and a processor coupled to the memory, wherein the processor is configured to perform acts of a service management method according to claim 15 based on instructions stored in the memory.

19. A non-transitory computer storage medium, on which a computer program is stored, wherein when the computer program is executed by a processor, a service management method according to claim 15 is implemented.

20. A configuration server, comprising a memory and a processor coupled to the memory, wherein the processor is configured to perform acts of a service management method according to claim 11 based on instructions stored in the memory.
